(19) United States
(12) Patent Application Publication
(10) Pub. No.: US 2015/0151674 A1
(43) Pub. Date: Jun. 4, 2015

(54) REARVIEW MIRROR WITH LIGHT TUBE

(71) Applicant: Chen-Wei HSU, Tainan (TW)

(72) Inventor: Chen-Wei HSU, Tainan (TW)

(21) Appl. No.: 14/096,036

(22) Filed: Dec. 4, 2013

(51) Int. Cl. B60Q 1/26; F21S 8/10

(52) U.S. Cl. CPC B60Q 1/2665; F21S 48/2206

(57) ABSTRACT

A rearview mirror includes a case, a light tube and a lens. The case has a slot defined in the outside thereof and the light tube is engaged with the slot. The lens is connected to the slot to cover the light tube. The light tube includes a silicone tube and two Light Emitting Diodes strings. The silicone tube has a flat bottom and a curved face on the top thereof. The silicone tube has a reception slot and a through hole. The two Light Emitting Diodes strings are positioned in the reception slot and have multiple Light Emitting Diodes connected thereto. Wires are connected to the two Light Emitting Diodes strings and extend through the installation hole of the case. The light beams from the Light Emitting Diodes are guided by the silicone tube and pass through the lens. The light beams are even and provide sufficient warning features.

### BACKGROUND OF THE INVENTION

1. Fields of the Invention

The present invention relates to a rearview mirror, and more particularly, to a rearview mirror with a light tube engaged therewith so as to provide more information to other drivers.

2. Descriptions of Related Art

The conventional rearview mirror is used to provide information of the following vehicles and/or pedestrians to the driver so as to increase the road safety. Some of the rearview mirrors are equipped with a directional light on the outside thereof and the directional light is a light tube with Light Emitting Diodes (LEDs) connected thereto. The LEDs are activated together with the turning light is operated so that the drivers and pedestrians on the rear end or lateral side of the vehicle are alerted. However, the conventional LEDs directly emit light beams which might be glared with sight of the drivers and pedestrians on the rear end or lateral side of the vehicle. Furthermore, the light tube includes three LEDs connected thereto, when one of the LEDs is damaged, the whole set of the three LEDs fail to function properly and has to be replaced.

The present invention intends to provide a light tube which is flexible and is matched with the curvature of the case of the rearview mirror, and the light is evenly and might not be glared with sight of the drivers and pedestrians on the rear end or lateral side of the vehicle.

### SUMMARY OF THE INVENTION

The present invention relates to a rearview mirror and comprises a case having a slot defined in the outside thereof. Multiple engaging holes are defined in the inside of the slot and an installation hole is defined in the end face of the slot. A light tube comprises a silicone tube and two Light Emitting Diodes strings. The silicone tube has a flat bottom and a curved face on the top thereof. The silicone tube has a reception slot and at least one through hole. The two Light Emitting Diodes strings are positioned in the reception slot. Multiple Light Emitting Diodes are connected to the two Light Emitting Diodes strings. Wires are connected to the two Light Emitting Diodes strings and extend through the installation hole of the case. A lens has multiple positioning members on the periphery thereof The positioning members are engaged with the engaging holes of the case.

Preferably, the bottom face of the silicone tube has adherent which fixes the light tube to the outside of the case.

Preferably, the curved face of the silicone tube has at least one groove and the light beams from the Light Emitting Diodes become even by passing through the at least one groove.

Preferably, the silicone tube has multiple ridges on two sides thereof and the ridges are engaged with the slot of the case.

Preferably, there are multiple refraction grooves formed in the reception slot and the refraction grooves are located corresponding to the curved face of the silicone tube. The refraction grooves refract the light beams from the Light Emitting Diodes.

The primary object of the present invention is to provide a light tube which is flexible to match the shape of the case of the rearview mirror.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the rearview mirror of the present invention;

FIG. 2 is a cross sectional view to show a portion of the rearview mirror of the present invention, and

FIG. 3 is a perspective view to show the rearview mirror of the present invention.

### DETAILED DESCRIPTION OF THE PREFERRED EMBODIMENT

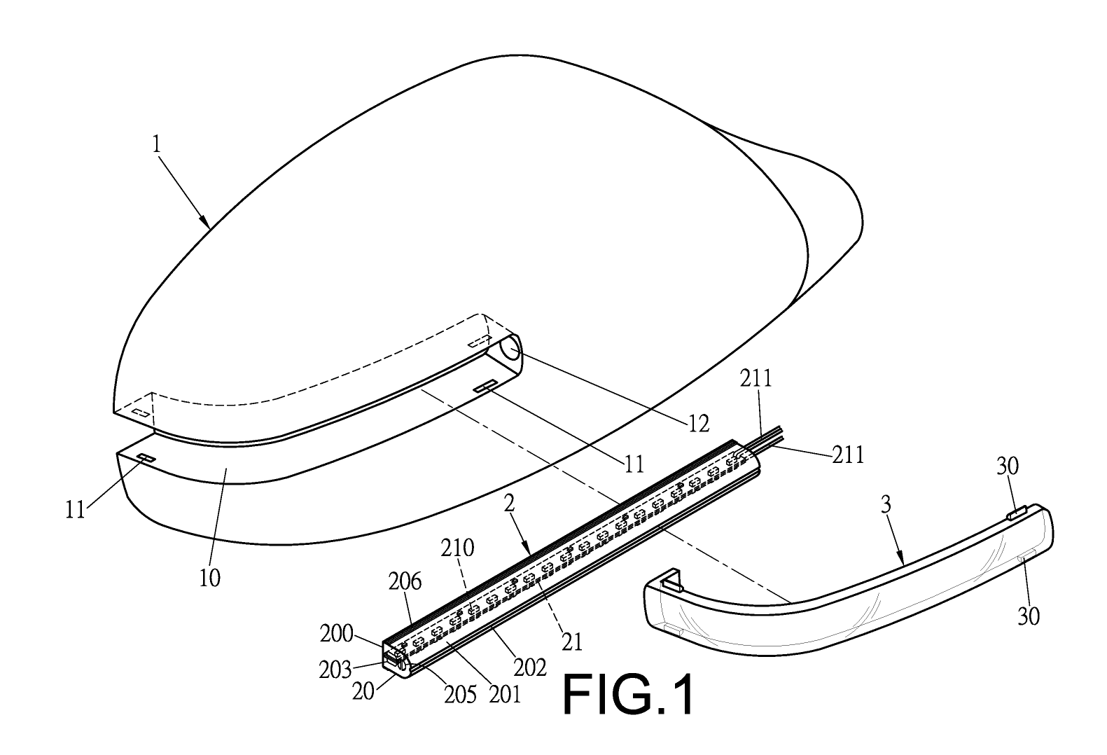

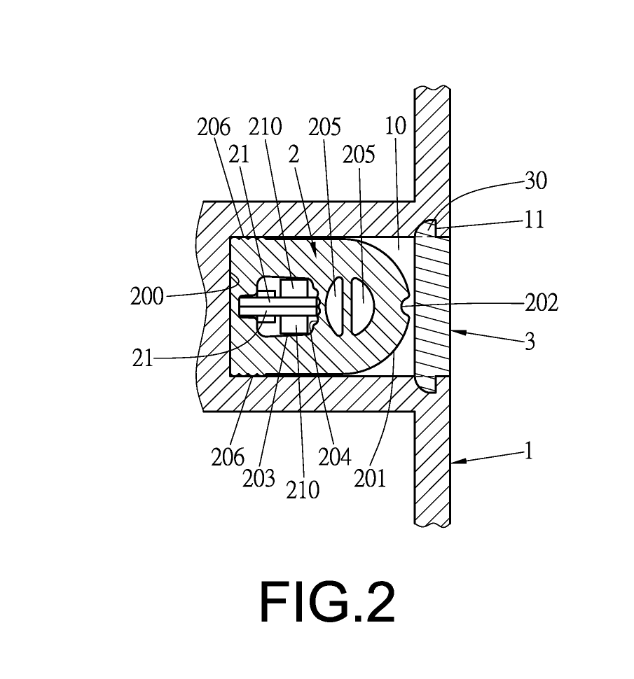

Referring to FIGS. 1 and 2, the rearview mirror of the present invention comprises a case 1, a light tube 2 and a lens 3. The case 1 has a slot 10 defined in the outside thereof and multiple engaging holes 11 are defined in two opposite insides of the slot 10. An installation hole 12 is defined in the end face of the slot 10.

The light tube 2 has a silicone tube 20 and two Light Emitting Diodes strings 21 as shown in FIG. 2. The silicone tube 20 has a flat bottom 200 and a curved face 201 on the top thereof. The curved face 201 of the silicone tube 2 has at least one groove 202. A reception slot 203 is defined in the silicone tube 20 and there are multiple refraction grooves 204 formed in the reception slot 203 and the refraction grooves 204 are located corresponding to the curved face 201 of the silicone tube 2. The silicone tube 2 has at least one through hole 205. The silicone tube 2 has multiple serrated ridges 206 extending from two sides thereof. The two Light Emitting Diodes strings 21 are positioned in the reception slot 203 and multiple Light Emitting Diodes (LEDs) 210 are connected to the two Light Emitting Diodes strings 21. Three LEDs 210 is one set on each of the two Light Emitting Diodes strings 21. Wires 211 are connected to the two Light Emitting Diodes strings 21 and extend through the installation hole 12 of the case 1. The lens 3 has multiple positioning members 30 on the periphery thereof, and the positioning members 30 are engaged with the engaging holes 11 of the case 1.

When in assembling, as shown in FIGS. 1 to 3, the two Light Emitting Diodes strings 21 are positioned in the reception slot 203 and the ridges 206 are engaged with the slot 10 of the case 1 to secure the light tube 2 in the slot 10 of the case 1. Alternatively, the bottom face 200 of the silicone tube 20 has adherent which fixes the light tube 20 in the slot 10 of the case 1. The wires 211 on the two Light Emitting Diodes strings 21 extend through the installation hole 12 of the case 1 and the lens 3 is engaged with the slot 10 by engaging the positioning members 30 with the engaging holes 11 of the case 1.

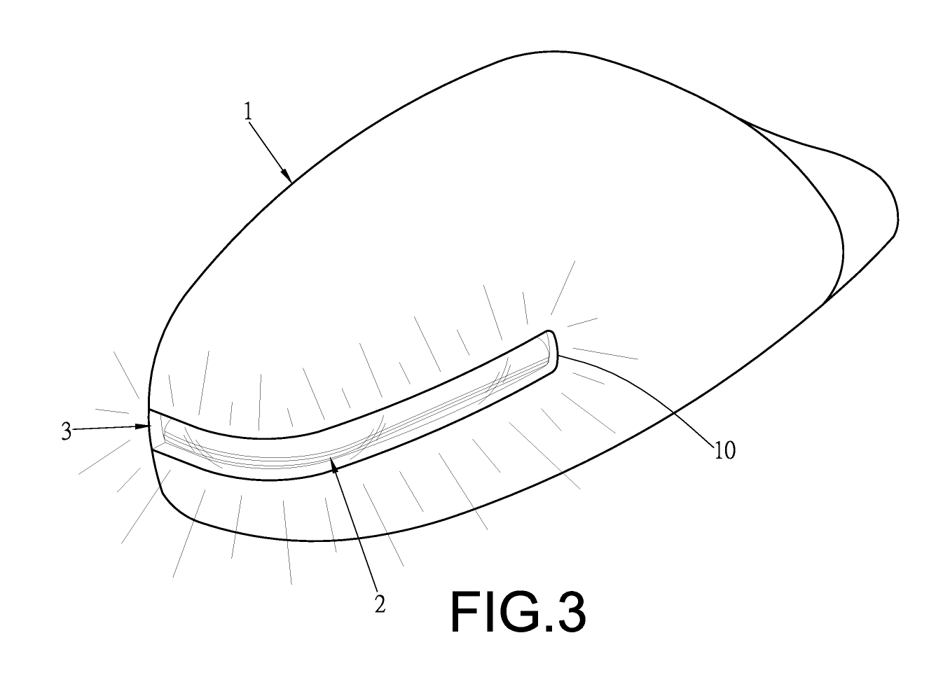

As shown in FIG. 3, when the driver operates the turning signal, the LEDs 210 of the two Light Emitting Diodes strings 21 are activated, and the light beams from the LEDs 210 pass through the silicone tube 20 which makes the light beams to be even. Three LEDs 210 is one set, and when one of the LEDs 210 fails, all of the three LEDs 210 fail. However, there are two Light Emitting Diodes strings 21 positioned in the reception slot 203 of the silicone tube 20, so that the light beams passing through the silicone tube 20 still provide sufficient and even illumination feature. The at least one groove 202 of the curved face 201 of the silicone tube 20 makes the light beams from the Light Emitting Diodes 210 become even when the light beams pass through the at least one groove 202 . The LEDs 210 in one of the two Light Emitting Diodes strings 21 are set to emit orange light beams and are connected with the circuit of the turning signals. The LEDs 210 that emit orange light is simultaneously activated when the turning signal is activated. The LEDs 210 in the other one of the two Light Emitting Diodes strings 21 are set to emit blue light beams and are connected with the circuit of the head lights so as to provide warning signals at night. There are multiple refraction grooves 204 formed in the reception slot 203 and the refraction grooves 204 are located corresponding to the curved face 201 of the silicone tube 20. The refraction grooves 204 refract the light beams from the LEDs 210 evenly so as to obtain even light beams seen by the following drivers and pedestrians. The silicone tube 20 is flexible so that it is able to be bent to be desired shape to match the curvature of the case 1. The through hole 205 provides sufficient space to allow the silicone tube 20 to be bent or deformed into desired shapes which can be used with the cases 1 of different brands. The light beams from the LEDs 210 of the Light Emitting Diodes strings 21 in the silicone tube 20 evenly come through the curved silicone tube 20 and provide better warning features at night so as to increase the driving safety.

While we have shown and described the embodiment in accordance with the present invention, it should be clear to those skilled in the art that further embodiments may be made without departing from the scope of the present invention.

What is claimed is:

1. A rearview mirror comprising:
a case having a slot defined in an outside thereof, multiple engaging holes defined in an inside of the slot, an installation hole defined in an end face of the slot;
a light tube having a silicone tube and two Light Emitting Diodes strings, the silicone tube having a flat bottom and a curved face on a top thereof, the silicone tube having a reception slot and at least one through hole, the two Light Emitting Diodes strings being positioned in the reception slot, multiple Light Emitting Diodes connected to the two Light Emitting Diodes strings, wires connected to the two Light Emitting Diodes strings and extending through the installation hole of the case, and
a lens having multiple positioning members on a periphery thereof, the positioning members engaged with the engaging holes of the case.
